(19) United States
(12) Patent Application Publication
(10) Pub. No.: US 2026/0246406 A1
(43) Pub. Date: Aug. 20, 2026

(54) METHOD FOR CONTROLLING AN ELECTRONICALLY COMMUTATED ELECTRIC MACHINE

(71) Applicant: AUMOVIO Germany GmbH, Frankfurt am Main (DE)

(72) Inventors: Bogdan Budianu, Oberursel (DE); Dominik Schulte, Mühltal (DE); Tom Kaufmann, Ippenschied (DE); Michael Wintzer, Frankfurt (DE)

(73) Assignee: AUMOVIO Germany GmbH, Frankfurt am Main (DE)

(21) Appl. No.: 19/545,627

(22) Filed: Feb. 20, 2026

(30) Foreign Application Priority Data
Feb. 20, 2025 (DE) 10 2025 106 470.9

(51) Int. Cl. H02P 25/06; H02P 23/00

(52) U.S. Cl. CPC H02P 25/06; H02P 23/00

(57) ABSTRACT

A method for controlling an electronically commutated electric machine for identifying an end position of a linear actuator comprises such an electronically commutated electric machine. The embodiments further relate to an electronically commutated electric machine which is designed for carrying out the method according, and to a brake device for a motor vehicle, comprising such an electric machine.

### TECHNICAL FIELD

A method for controlling an electronically commutated electric machine and for identifying an end position of a linear actuator is disclosed.

### BACKGROUND

In modern motor vehicles, electronically commutated electric machines are used in a wide variety of applications. For example, electric machines, for example brushless electric motors, are often used as actuators, for example for window regulators or seat adjustment means.

The electric machine may comprise a stator and a rotor, wherein the rotor may be mounted in the stator. Such electrical machines are generally fed via energy stores internal to the vehicle that provide a direct voltage. A multiphase, usually three-phase output current can be generated by means of a power converter (for example a B6 bridge), which output current can be fed to the stator coils of the electric machine in order to generate a rotating rotary magnetic field by means of which the rotor can be made to rotate. The rotor may accordingly be designed to be permanently excited. The phases of the three-phase current generated by the power converter and of the associated rotating field are also referred to as motor phases in this case.

For reliable control of the electric machine, it is important to know the exact rotor position or rotor orientation in order to be able to correspondingly control the output current of the phases, which is typically provided with pulse width modulation, or to be able to supply the motor phases with current at the correct time.

For this purpose, rotary position measuring systems are available which make it possible to determine the orientation or the rotor position of the rotor within the stator. In addition, various calibration methods can additionally be used to compensate for possible mechanical or electrical faults. Corresponding rotor position sensors, for instance Hall sensors, may be used to measure rotor position signals.

The contact systems used in these rotary position measuring systems generally assume an uninterrupted electrical contacting, such that the control reliably functions. When using rotary position measuring systems, however, it is possible that correspondingly constructed contact systems, for instance under particular loads such as high temperatures or on account of mechanical stresses in components, dynamic influences or due to aging phenomena, lead to electrical contacting, in the case of which short-term resistance fluctuations or even contact interruptions cannot be completely ruled out, and so that under certain circumstances there are no longer any sensor signals for determining the rotor position.

In safety-relevant applications or fields of use of such electric machines, it may however be necessary for the regulation to be able to place the electric machine into an emergency operation or into a safety mode even if sensor signals are no longer available. When electric machines of this kind are used, for example, in the field of electromechanical wheel brakes for motor vehicles, it may be required, for example, for the electromechanically actuatable wheel brake to continue to remain functional even in the event of a failure of a sensor signal, or to fall into a safety mode or a fallback level ("RFE"), if it is no longer possible to determine the rotor position or the rotor orientation due to faulty or absent sensor signals.

For example, in the event of a failure of sensor signals, a reference run may be required in order to determine an end position of a linear actuator with the electric machine. This can lead to damage to end stops if, for example, the electric motor hits an end stop at excessive speed.

Accordingly a method for controlling an electronically commutated electric machine which mitigates, or does not have, the above-mentioned disadvantages is desired.

### SUMMARY

In this context, the electric machine should be able to be safely operated for example even when no sensor signals from a rotor position sensor are available to the control system.

This object is achieved by means of a method for controlling an electronically commutated electric machine, a method for identifying an end position of a linear actuator, a linear actuator and a brake device for a motor vehicle.

A first aspect comprises a method for controlling an electronically commutated electric machine having a rotor and a stator, having the following steps: controlling the electric machine by means of a control device, wherein the rotor rotates in a first direction of rotation, controlling the electric machine by means of the control device in a safety operating mode in a second, opposite direction of rotation, detecting and/or observing the back electromotive force of the induction coils of the stator in the safety operating mode, preferably by means of a BEMF observer, checking, whether the end stop conditions are met, and setting the current rotor position as a default value for an end position and transferring this position information to the control device if the end stop conditions are met over a predetermined time period or over a predetermined number of sampling steps. The end stop conditions are a rotation of the rotor can be observed, for example against the direction of rotation required in the safety operating mode, and a validity condition of the BEMF observer is met.

The embodiments make it possible to continue to safely operate the electronically commutated electric machine even in the event of failure of at least one or even all of the sensor signals of a rotor position sensor. The method thus provides additional safety for the operation of such electric machines, which means that important positions of the rotor, for example end positions or end states or end stops, can be detected even in the event of failure of the sensor signals. Therefore, referencing of the electric machine can be made possible in such situations as well. As a result, possible damage to the electric machine can be avoided and, after successful referencing, continued operation can also be made possible.

The electronically commutated electric machine may comprise a stator and a rotor, wherein the rotor may be designed to be permanently excited and wherein the stator may have coils or induction coils which can be electrically energized for actuation in order to generate a rotating magnetic field or rotating stator field. According to one embodiment, the rotor is mounted within the stator. In principle, however, the method is also able to be used for other designs, for example with current-excited rotors.

Thus it is possible to use the electronically commutated electric machine for driving a linear actuator or together with a linear actuator, wherein the linear actuator can have at least one end stop which defines an end state or end position. The first direction of rotation may indicate a direction of application and the second direction of rotation may specify a direction of release.

In a further aspect, a method for identifying an end position of a linear actuator, comprising an electronically commutated electric machine, having the following steps, for example in the order shown below: controlling the electric machine by means of the control device in a safety operating mode in a direction of release, detecting and/or observing the back electromotive force of the induction coils of the stator in the safety operating mode, for example by means of a BEMF observer,checking, whether the end stop conditions are met, and setting the current rotor position as a default value for an end position of the linear actuator and transferring this position information to the control device if the end stop conditions are met over a predetermined time period or over a predetermined number of sampling steps. The end stop conditions are a rotation of the rotor can be observed, for example against the direction of rotation required in the safety operating mode, and a validity condition of the BEMF observer is met.

In this way, the method can also be used for, for example, an electromechanically actuatable wheel brake of a motor vehicle, which often have electrically driven linear actuators as pressure setting means.

Accordingly, in a further aspect, a linear actuator, comprises an electronically commutated electric machine having a rotor and a stator, designed to carry out a method as stated above.

Furthermore, the present embodiments also relate, in yet a further aspect, to a brake device of a motor vehicle, comprising such a linear actuator, for example as a pressure setting device for an electromechanically actuatable wheel brake.

The embodiments make use of the so-called back electromotive forces (back-EMF or "back electromotive force", BEMF). The methods based thereon are therefore also referred to as BEMF methods. By means of the BEMF method, induced voltage signals due to a back electromotive force, which are induced in the phase windings by the magnets of the rotor, can be detected. Accordingly, a BEMF method can be used at least in the safety operating mode. The BEMF method can be implemented, for example, by correspondingly designed function blocks in the control unit, wherein these function blocks or circuit arrangements can then constitute the BEMF observer. The method accordingly operates, at least in the safety operating mode, without sensors. This means that, at least in the safety operating mode, no sensor signals of an additional position sensor, such as a Hall sensor, must be used, which promotes the use of BEMF methods for such cases.

The back electromotive forces are proportional to the rotational speed of the rotor and therefore permit, for example at higher rotational speeds, a rotor position determination which can be used for controlling and motor regulation by the control unit. The back-EMF thus reflects the instantaneous angular velocity of the rotor. The voltage corresponds to the back-EMF, which can be observed.

A known method for detecting the back-EMF is known for example from WO 2024/132553, and will therefore only be briefly outlined here. In the BEMF method described, the rotor flux is estimated by a BEMF observer, or the BEMF information is extracted from relationships of voltage and current based on a motor model. In electric machines or AC electric machines, such as for example synchronous machines having permanent magnets, BEMF methods can normally be used very well for estimating the rotor position and rotor speed. A BEMF observer may comprise complex estimation algorithms, wherein correction terms can be used based on measured and estimated signals. In this case, provision may be made for the BEMF observer to also provide correction terms based on measured and estimated currents in a α-β-stationary reference frame. A possible procedure for estimating rotor flux is disclosed in WO 2024/132553, which is hereby incorporated in full. The determination of the back-EMF is also described in more detail in US 9,484,849 by applicant, which is also hereby incorporated in full.

At higher rotational speeds of the rotor, the voltage can be detected easily since the forces acting are sufficiently high. However, at lower rotational speeds, for example below 500 or 400 rpm depending on the design of the electric machine, detection proves to be more difficult, or no longer possible, since the induced forces turn out to be lower and ultimately can no longer be detected without error. However, retraction of the linear actuator at a higher rotational speed that can be sensed through BEMF can lead to damage to the end stops.

Here, the electric machine may firstly be controlled by the control device, wherein the rotor rotates in a first direction of rotation. This may take place on the basis of an actuation control command, for example on the basis of a braking request by an electromechanically actuatable wheel brake, such that application of the wheel brake by the linear actuator occurs upon a rotation of the rotor in the first direction of rotation. By means of the control command, the motor phases of the electric machine can accordingly each be supplied with a PWM signal, based on a current measurement for generating the rotating magnetic field, in such a way that the rotor rotates. Thus, in a current vector mode, a rotating magnetic field is generated in the stator ("stator rotating field"), which the rotor follows. In the context of the embodiments, it is assumed that a rotational speed (n) is proportional to an angular velocity (ω) and the rotational speed can be calculated from the angular velocity. In this respect, the two terms are used interchangeably.

If sensor signals are no longer present, the rotor position and thus the position of the linear actuator are not always known. However, an exact rotor position is necessary for further control in order to allow a renewed actuation. Thus, for example in the case of electromechanically actuatable wheel brakes, after each braking process, i.e. after each application of the wheel brake to apply an application force, the linear actuator must be retracted into an initial or zero position.

Accordingly, a safety operating mode may therefore be provided after each actuation of the electric machine, that is to say, for example, after an application. In this context, the electric machine can be fed by the control device with a safety control command, which requires a direction of rotation opposite to the direction of application, in order to carry out a reference travel in the direction of an end stop.

In order to avoid a situation in which, during a backward rotation of the rotor or backward movement, a rearward end stop is approached at too high a speed, which can lead to damage, the electric machine is controlled by the control device in the safety operating mode with a rotational speed specification which does not exceed a predefined maximum safety rotational speed. This may be selected in a manner dependent on the design of the electric machine, such that damage to the end stop can be reliably avoided.

Accordingly, a low or very low safety rotational speed can be deliberately selected, for example - 400 rpm or less, for example - 350 rpm or less, e.g. - 300 rpm or even less. The negative sign in this case indicates the "backward rotation" in the second direction of rotation or in the direction of release. At such low rotational speeds, however, the back-EMF cannot be detected reliably or not at all, since the induced voltages are too low due to the low rotational speed.

In the case of a sufficiently slow backward rotation of the rotor of the electric machine in the safety operating mode, the rotor follows the rotating magnetic field until the end stop is reached, provided that no load is active. When the end stop is reached, the rotor stops, wherein the applied rotating magnetic field continues to rotate. This increases the angle between the applied rotating magnetic field in the stator, on the one hand, and the rotor, which is stationary at this time, on the other hand.

If this resulting angle between the applied rotating magnetic field or stator rotating field and the rotor now increases from a few degrees to an order of magnitude of approximately 180°, the rotor is rotated abruptly in the opposite, first direction of rotation. Accordingly, a "tipping over" of the rotor occurs, that is to say an abrupt change in the direction of rotation, which can be increased further by elastic energy stored in the end stop. Accordingly, the rotor no longer follows the direction of rotation of the applied magnetic field.

These forces can lead to a jump pulse on the rotor, which leads to a higher rotational speed in the reverse direction of rotation. This rotational speed may even be higher than the required safety rotational speed. For example, this rotational speed can also be so high that it exceeds the threshold at which the back-EMF can be detected.

The BEMF observer can detect this event. The BEMF observer may be designed to output and/or estimate a BEMF angle or rotor angle and a BEMF angular velocity of the rotor. From this, the rotor position can be estimated. If a rotation of the rotor is now observed by the BEMF observer, then - if the rotor has reached the end position - only a rotation in the opposite direction, i.e. the first direction of rotation, can have taken place. The BEMF observer can thus observe a rotation of the rotor, for example against the first direction of rotation or against the direction of release.

In order to ensure reliable detection, a validity condition ("BEMF validity") can be introduced. This can be met when a BEMF observer error does not exceed a predefined limit value, and/or when the output amplitude of the determined BEMF signals exceeds a predetermined limit value. The BEMF observer error can be obtained here from the difference between the measured phase currents and the modeled phase current of the observer.

Accordingly, the following end stop conditions can thus be defined, indicating the reaching of an end position of the rotor, provided that they are met. The end stop conditions may comprise: a rotation of the rotor can be observed, e.g. against the direction of rotation required in the safety operating mode, and the validity condition is met.

In order to be able to reliably detect when the end position of the rotor has been reached, it can furthermore be stipulated that the end stop conditions are to be met over a predetermined time period or a predetermined number of sampling steps. This makes it possible to prevent faulty signals from leading to incorrect end position detection. It is thus possible, for example, to require that the end stop conditions are present over at least 10, for example at least 20 samplings, e.g. at least 30 samplings or more, or over a time period of at least 1 mms, for example at least 2 ms, e.g. of at least 3 ms or even more.

In this way, referencing of the electric machine can be performed without sensors in the safety operating mode, and the current rotor position can be set as a default value for the end position and can be transferred to the control device as position information.

The electric machine can subsequently be controlled further or again by the control device.

Further details will emerge from the description of the illustrated exemplary embodiments and from the appended claims.

### BRIEF DESCRIPTION OF THE DRAWINGS

The drawings show:

FIG. 1 shows an exemplary representation of a circuit with a BEMF observer,

FIG. 2 shows a more detailed exemplary circuit arrangement of the BEMF observer from FIG. 1,

FIG. 3 shows a functional diagram of the method, and

FIG. 4 shows an exemplary representation of various signal profiles over time.

### DETAILED DESCRIPTION

In the following detailed description of embodiments, identical reference numerals for the sake of clarity denote substantially identical parts in or on these embodiments. To better illustrate the embodiments illustrated in the figures are however not always drawn to scale.

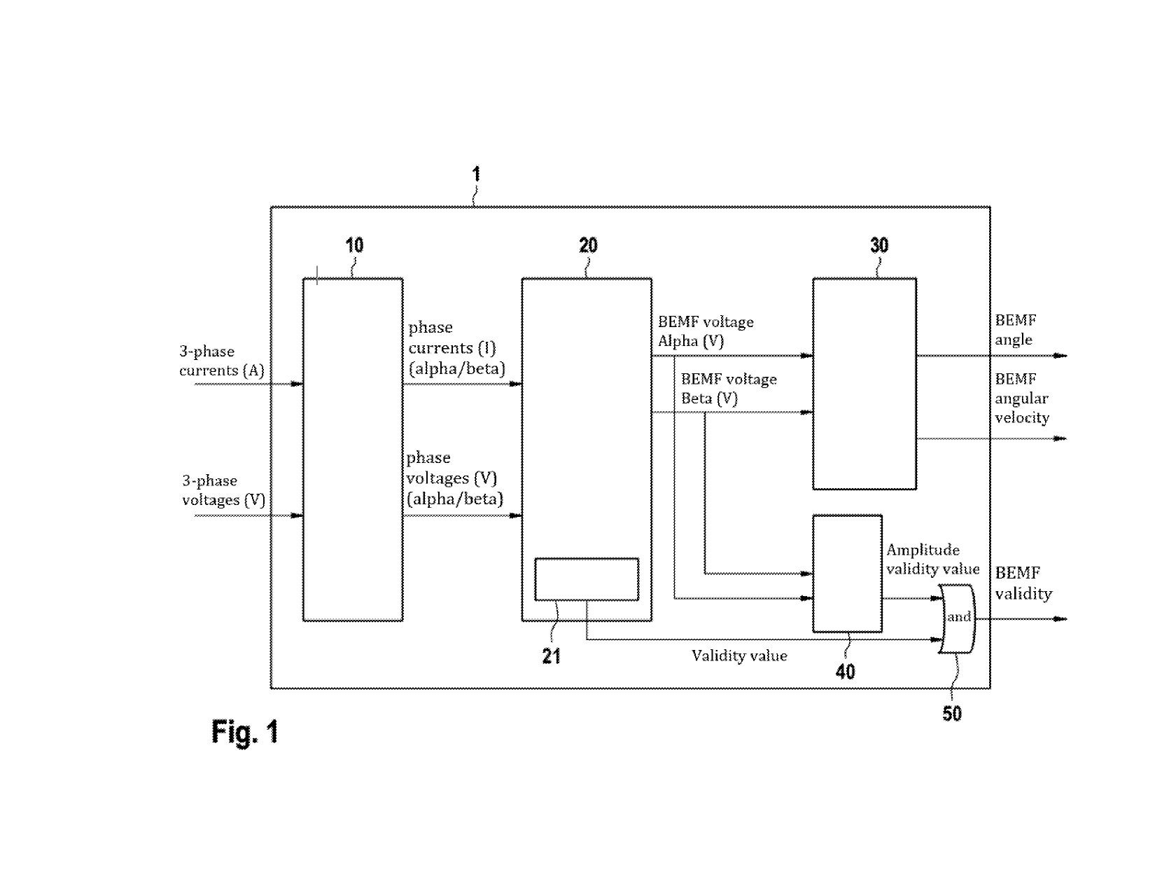

FIG. 1 shows an exemplary representation of a circuit 1 with a BEMF observer 20. The circuit 1 is integrated in the control device of the electronically commutated electric machine (not shown), but can also be implemented in a superordinate control unit.

Where an observer is referred to in the context of these embodiments., this may generally be understood to mean means or electronic circuits that allow a corresponding control implementation of the desired functionality. The conversion can be carried out by means of a function block with a corresponding circuit arrangement.

The electronically commutated electric machine is embodied as a three-phase electric motor and, in addition to the control device for controlling, comprises a permanently excited rotor and a stator with coils which can be electrically energized via electrical line paths.

From the measured voltages in the stator coils, it is possible to calculate the voltage which is induced in the stator windings by the movement of the rotor.

Three phase currents and three phase voltages are shown here as input variables for the circuit 1. The input variables are based on measured stator currents and measured or estimated stator voltages. These are transferred into a stationary α-β coordinate system by a function block 10, which performs a Clarke transformation in the example.

The phase currents and phase voltages in the α-β coordinate system are then supplied to the BEMF observer 20, which comprises appropriate means for calculating the BEMF voltages in the α-β coordinate system. The BEMF voltages in the α-β coordinate system are transmitted to an angle observer 30, which outputs the BEMF angle and the BEMF angular velocity from these values. The rotor position or rotor state can be determined from these values.

The BEMF observer 20 also comprises a validity observer 21, which observes the transient response. A corresponding limit value can be determined for this purpose. If the transient response has the desired quality, a corresponding signal ("valid" = "true") can be output as a validity value to an AND link 50, which corresponds more or less to a quality criterion of the signal quality of the BEMF observer

In addition, the magnitude of the amplitudes of the BEMF voltages in the α-β coordinate system is checked by an amplitude observer 40, which outputs a further amplitude validity value to the AND link 50. The magnitude of the amplitude is proportional to the rotor rotational speed and thus constitutes a further quality criterion. An amplitude that is too low can indicate problems in the system, such as faults such as short circuits, open circuits, or other anomalies. Particularly at low rotational speeds, at which the back-EMF becomes very low, the signal quality can be impaired, so that the validity condition cannot be met.

Insofar as the validity value from the validity observer 21 and the amplitude validity value meet the required criteria, the AND link 50 outputs a corresponding signal for BEMF validity, which indicates that the validity condition of the BEMF observer is met.

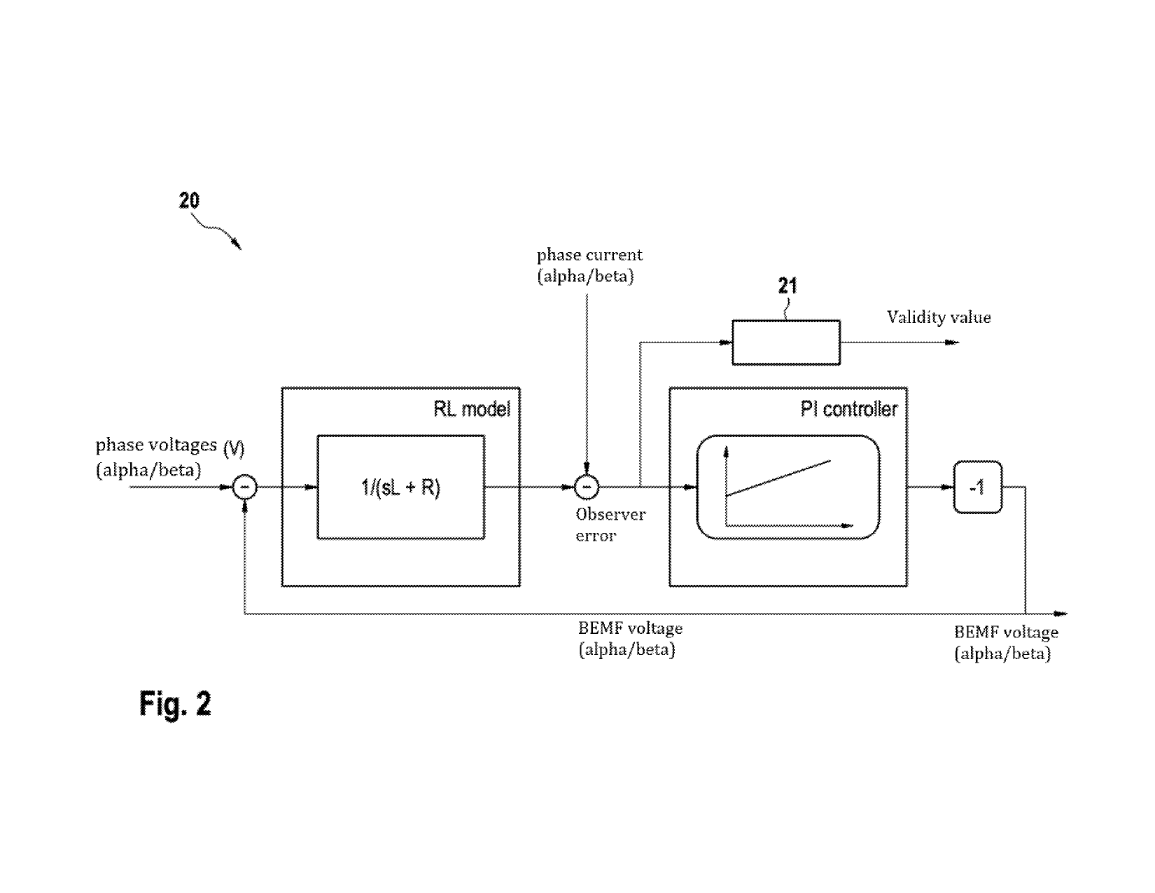

FIG. 2 shows a more detailed exemplary circuit arrangement of the BEMF observer 20 from FIG. 1. For the validity observer 21, a magnitude for the current of 1 A can be specified, for example, as a prescribed threshold, which of course can also have other threshold values adapted to the electric machine. The BEMF voltages in the α-β coordinate system (BEMF voltage alpha/beta) and the validity value ("value" = "true" or "false") are output as output variables.

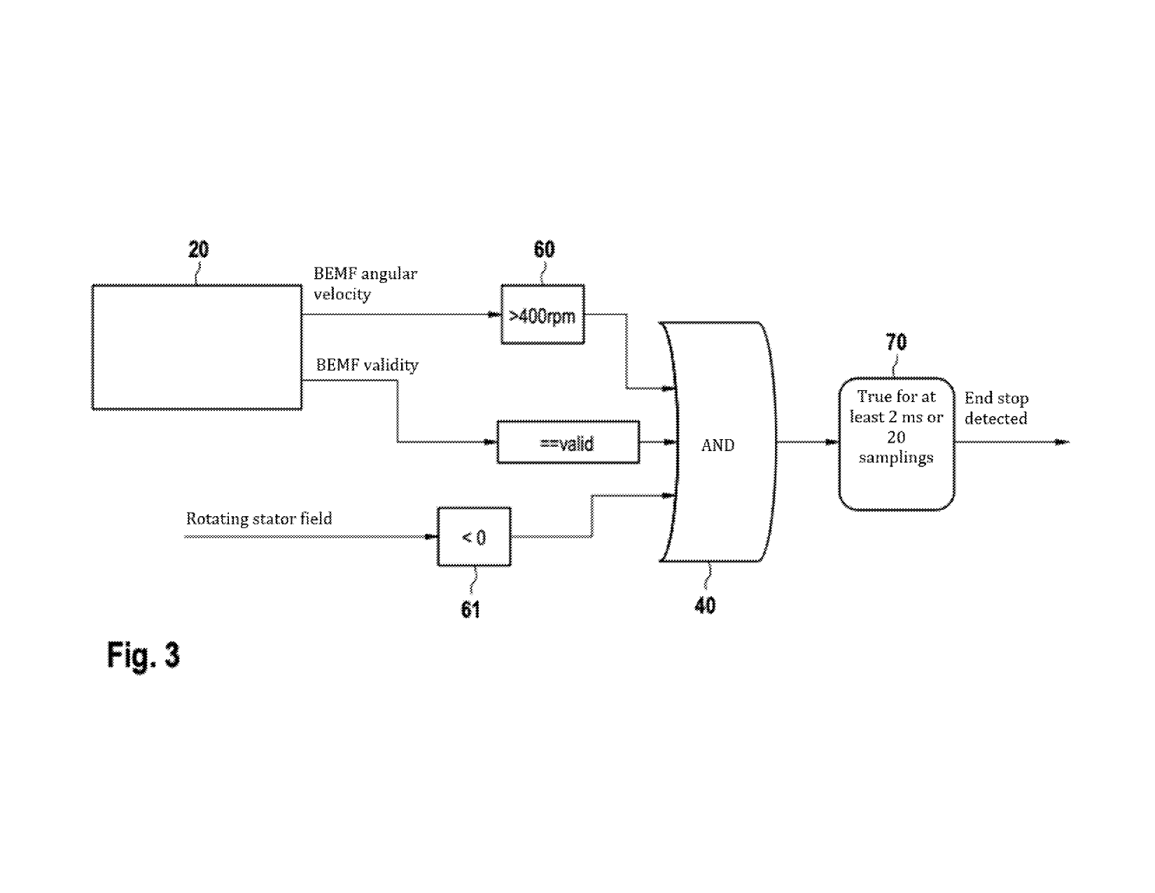

FIG. 3 shows an exemplary functional diagram of the method. The method for controlling an electronically commutated electric machine having a rotor and a stator accordingly has the following steps for example in the order illustrated: controlling the electric machine by means of the control device, wherein the rotor rotates in a first direction of rotation, controlling the electric machine by means of the control device in a safety operating mode in a second, opposite direction of rotation, detecting and/or observing the back electromotive force of the induction coils of the stator in the safety operating mode, preferably by means of a BEMF observer,checking, whether the end stop conditions are met, setting the current rotor position as a default value for an end position and transferring this position information to the control device if the end stop conditions are met over a predetermined time period or over a predetermined number of sampling steps. The end stop conditions are a rotation of the rotor can be observed, in particular against the direction of rotation required in the safety operating mode, and a validity condition of the BEMF observer is met.

According to an embodiment, the electronically commutated electric machine is used for driving a linear actuator or together with a linear actuator, wherein the linear actuator has at least one end stop. According to an embodiment, the linear actuator is used as a pressure setting device in a brake device of a motor vehicle.

The electric machine is controlled by the control device, wherein the rotor rotates in a first direction of rotation. This may take place based on an actuation control command in a normal operating mode.

According to an embodiment, control in the safety operating mode takes place after actuation of the electric machine or after termination of the actuation control command. Here, the electric machine is supplied with a control command, which requires an opposite direction of rotation or a direction of release, by the control device in order to reach the end stop by means of a reference travel. Here, the electric machine is controlled by the control device in the safety operating mode with a rotational speed setting which does not exceed a predefined maximum safety rotational speed.

In the exemplary embodiment in FIG. 3, this rotational speed setting is denoted by "stator rotating field". A corresponding signal is fed to a rotational speed checker 61, which, in the exemplary embodiment shown, checks whether this is negative (< 0), which means that the rotor rotates backwards in the second direction of rotation. The rotational speed setting is selected accordingly here and can assume, for example, values such as - 400 rpm or - 350 rpm, wherein the "-" indicates the direction of release.

When the end stop is reached, the rotor stops, wherein the applied rotating magnetic field rotates further. When this resulting angle between the stator rotating field and the rotor now increases to an order of magnitude of approximately 180°, the rotor is rotated abruptly in the opposite, first direction of rotation. Accordingly, a "tipping over" of the rotor occurs, thus an abrupt change in the direction of rotation, which can be increased further by elastic energy stored in the end stop. The rotor accordingly no longer follows the direction of rotation of the applied stator rotating field. In FIG. 3, this can be detected by a rotational speed checker 60, which is configured in the exemplary embodiment to check whether the BEMF angular velocity reaches or exceeds a first rotational speed threshold. In the exemplary embodiment, this first rotational speed threshold is set to the value of at least 400 rpm solely for illustrative purposes.

This results in the end stop conditions, both of which must be met: a rotation of the rotor can be observed, in particular against the direction of rotation required in the safety operating mode, and the validity condition of the BEMF observer is met.

These signals are supplied to the AND link 40.

In order to be able to reliably detect when the end position of the rotor has been reached, a time checker 70 is also provided, which is arranged in the signal-transmitting direction after the AND link and checks whether a predefined time condition is met. In the exemplary embodiment, the time checker 70 checks whether the end stop conditions are met over a predetermined time period or a predetermined number of sampling steps. This makes it possible to prevent faulty signals from leading to incorrect end position detection. In the exemplary embodiment shown, the time condition is met purely for illustrative purposes if the detected change in the direction of rotation of the rotor takes place over at least 20 samplings or over a time period of at least 2 mgs. If the time condition is also met, the end stop can be detected and indicated ("end stop detected").

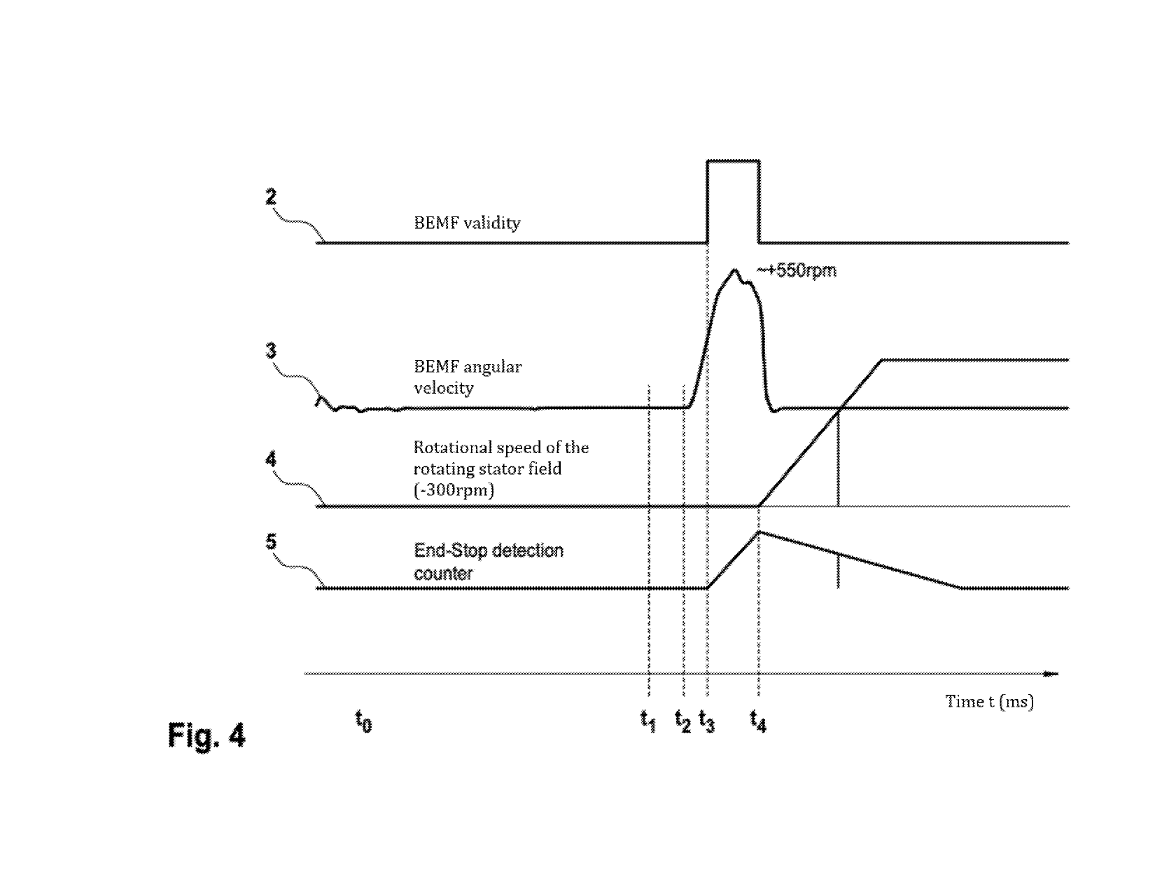

Finally, FIG. 4 shows an exemplary representation of various signal profiles over time t.

The time profile marked with reference numeral 2 shows the BEMF validity, which can assume the value 0 (not met, "valid" = "false") or the value 1 (validity met, "valid" = "true").

The time profile provided with reference numeral 3 shows the BEMF angular velocity, reference numeral 4 shows the rotational speed of the stator rotating field and reference numeral 5 shows an end stop detector ("end-stop detection counter"). In the exemplary embodiment shown, the predefined rotational speed of the stator rotating field is - 300 rpm (-300 rpm), which is applied to the electric machine at time t₀.

According to the exemplary embodiment shown, the end stop is reached approximately at time t₁. At time t₂, a display of the BEMF angular velocity, which indicates a reversal point, begins, wherein, however, the circuit arrangement 1 is capable of detecting the change in the direction of rotation of the rotor only when the BEMF validity is present at time t₃. At time t₄, the BEMF validity is lost again, since the jump pulse is then terminated. In the time period between t₃ and t₄, which in the exemplary embodiment is approx. 2 ms, the BEMF observer can produce valid values, and in this time interval the end stop can be detected.

1. A method for controlling an electronically commutated electric machine comprising:
controlling the electric machine by a control device, wherein the rotor rotates in a first direction of rotation,
controlling the electric machine by the control device in a safety operating mode in a second, opposite direction of rotation,
detecting the back electromotive force of the coils of the stator in the safety operating mode by a BEMF observer,
checking, whether both end stop conditions are met:
a rotation of the rotor can be observed against the direction of rotation required in the safety operating mode, and
a validity condition of the BEMF observer is met, and
setting the current rotor position as a default value for an end position and transferring the default value position information to the control device when the end stop conditions are met over one of a predetermined time period and a predetermined number of sampling steps.

2. The method as claimed in claim 1, wherein the electric machine comprises a stator and a rotor, wherein the rotor is permanently excited and wherein the stator has coils which can be electrically energized for controlling to generate a rotating magnetic field.

3. The method as claimed in claim 1, further comprising supplying the motor phases of the electrical machine in each case with a PWM signal based on a current measurement for generating a rotating magnetic field such that the rotor rotates.

4. The method as claimed in claim 1, further comprising executing the safety operating mode after control has ended of the electric machine by a control device.

5. The method as claimed in claim 1, wherein controlling in the safety operating mode is carried out at a predefined maximum safety rotational speed.

6. The method as claimed in claim 1, wherein the safety rotational speed is - 400 rpm or less.

7. The method as claimed in claim 1, wherein the detecting of the rotational speed of the rotor is carried out without sensors at least in the safety operating mode.

8. The method as claimed in claim 1, wherein the validity condition is met when the BEMF observer error does not exceed a prescribed limit value and when the output amplitude of the determined BEMF signals exceeds a predetermined limit value.

9. The method as claimed in claim 1, wherein the predetermined time period is at least 1 ms.

10. The method as claimed in claim 1, wherein the predetermined number of sampling steps amounts to at least 10 samplings.

11. The method as claimed in claim 1, wherein the electric machine is used to drive a linear actuator, wherein the linear actuator has at least one end stop.

12. The method as claimed in claim 1, wherein the first direction of rotation specifies a direction of application and the second direction of rotation indicates a direction of release.

13. A method for identifying an end position of a linear actuator comprising:
controlling the electric machine with a control device in a safety operating mode in a direction of release;
detecting the back electromotive force of the coils of the stator in the safety operating mode by a back electromotive force (BEMF) observer;
checking that the end stop conditions are met:
a rotation of the rotor can be observed against the direction of rotation required in the safety operating mode, and
a validity condition of the BEMF observer is met; and
setting the current rotor position as a default value for an end position of the linear actuator and transferring this position as an end position to the control device when the end stop conditions are met over one of a predetermined time period and predetermined number of sampling steps.

14. A linear actuator comprising:
an electronically commutated electric machine having a rotor and a stator; and
a control device with instructions for:
detecting the back electromotive force of the coils of the stator in the safety operating mode by a back electromotive force (BEMF) observer;
checking that the end stop conditions are met:
a rotation of the rotor can be observed against the direction of rotation required in the safety operating mode, and
a validity condition of the BEMF observer is met; and
setting the current rotor position as a default value for an end position of the linear actuator and transferring this position as an end position to the control device when the end stop conditions are met over one of a predetermined time period and predetermined number of sampling steps.

15. The linear actuator of claim 14, wherein the linear actuator is for brake device of a motor vehicle.
